(19) United States
(12) Patent Application Publication
(10) Pub. No.: US 2019/0336954 A1
(43) Pub. Date: Nov. 7, 2019

(54) CORE-SHELL HYBRID CHABAZITE MATERIAL WITH A WIDE SILICON TO ALUMINUM RATIO (SAR) ACTIVITY WINDOW

(71) Applicant: Pacific Industrial Development Corporation, Ann Arbor, MI (US)

(72) Inventors: Wei Wu, Ann Arbor, MI (US); Geng Zhang, Utsunomiya (JP); De Gao, Troy, MI (US); David Shepard, South Lyon, MI (US); Yunkui Li, Ann Arbor, MI (US); Jeffery Lachapelle, Northville, MI (US)

(21) Appl. No.: 15/967,896

(22) Filed: May 1, 2018

(51) Int. Cl. B01J 29/76; B01J 29/70; B01J 35/00; B01J 35/10; B01J 37/30; B01J 37/02; B01D 53/94; F01N 3/20

(52) U.S. Cl. CPC B01J 29/763; B01J 29/7015; B01J 29/7065; B01J 35/0006; B01J 35/1023; B01J 35/1038; B01D 2255/50; B01J 37/30; B01J 37/0221; B01D 53/9418; F01N 3/2066; B01J 2229/16; B01J 2229/183; B01J 35/1057

(57) ABSTRACT

A crystalline, core-shell hybrid Chabazite (CHA) material for use as a catalyst has a core with a silicon to aluminum ratio (SAR) that is less than 25 and a shell that at least partially encapsulates the core, the shell having an SAR of about 25 or greater. The crystalline, core-shell hybrid Chabazite is prepared by forming a first chabazite (CHA) material having a silicon to aluminum ratio (SAR) that is less than 25, placing the first CHA material into an aqueous reaction mixture comprising one or more precursors capable of forming a second chabazite (CHA) material having an SAR that is 25 or greater, growing the second CHA material on the surface of the first CHA material, and collecting the core-shell hybrid CHA material.

### FIELD

This disclosure relates to an alumina silicate zeolite-type material for use as a catalyst in Selective Catalytic Reduction (SCR) reactions and a process of forming said catalyst.

### BACKGROUND

The statements in this section merely provide background information related to the present disclosure and may not constitute prior art.

A zeolite is a crystalline aluminosilicate having a framework based on an extensive three dimensional network of oxygen ions. The fundamental building block of all zeolites is a tetrahedron of four oxygen anions surrounding a small silicon or aluminum ion. These tetrahedra are arranged so that each of the four oxygen anions is shared in turn with another silica or alumina tetrahedron. The crystal lattice extends in three-dimension, and the −2 charge, i.e., oxidation state, of each oxygen anion is accounted for. Each silicon ion has its +4 charge, balanced by the four tetrahedral oxygen anions, and the silica tetrahedral are therefore electrically neutral. Each aluminum tetrahedron has a −1 residual charge since the trivalent aluminum is bonded to four oxygen anions. This is balanced by cations that occupy non-framework positions and act as strong, acid-donating Brønsted sites as further described in the schematic below.

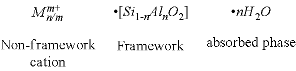

High-silica containing zeolites or molecular sieves are typically prepared from an aqueous reaction mixture containing sources of an alkaline metal or an alkaline earth metal oxide; sources of an oxide of silicon; optionally sources of aluminum oxide; and a cation derived from 1-Adamantamine, its derivative N,N,N-trimethyl-1-adamantamonium hydroxide, and mixtures thereof. Fumed silica is used as the typical source of silicon oxide, while aluminum hydroxide is used as the typical source of aluminum oxide. The “as synthesized” crystalline zeolite formed by crystallization may then be subjected to further treatment. For example, the structure directing agent (SDA) can be removed by thermal treatment (i.e. calcination). Such further treatments include the removal of the metal cation by ion-exchange using known methods such as using a diluted acid solution or ammonium nitrate solutions.

U.S. Pat. No. 4,544,538, discloses a method of preparing the SSZ-13 molecular sieve in the presence of N,N,N-trimethyl-1-adamantamonium cation, which is known as the organic template and acts as the structure directing agent (SDA). The strongly directing template species control the course of the reaction by serving primarily to establish the pH conditions of the reaction mixture. The N,N,N-trimethyl-1-adamantamonium cation has been known to crystallize different zeolite structures in the presence of various amount of the inorganic metal.

Y. Nakagawa et al. in Microporous and Mesoporous Materials, 22, (1998) p. 69-85 have computationally determined five different zeolites that can be made using the N,N,N-trimethyl-1-adamantamonium cation. Their molecular modeling calculations agree with their experimental data. They have reported that this template crystallizes SSZ-13, SSZ-23, SSZ-24, SSZ-25, and SSZ-31 type of zeolites. They show the crystallization field boundaries for the five zeolites commonly made by two SDA's. N,N,N-trimethyl-1-adamantamonium SDA molecule crystallizes chabazite phase at SAR 10-40, while STT phase at SAR 50-70.

### BRIEF DESCRIPTION OF THE DRAWINGS

The drawings described herein are for illustration purposes only and are not intended to limit the scope of the present disclosure in any way.

FIG. 1A is a schematic representation of a core-shell hybrid Chabazite material formed according to the teachings of the present disclosure;

FIG. 1B is a photographic image of the core-shell hybrid Chabazite material prepared according to the teachings of the present disclosure;

FIG. 2 is an x-ray powder diffraction analysis spectrum of a material prepared according to Example 1 both in a fresh state and after hydrothermal aging at 800° C. for 6 hours, 10% H2O);

FIG. 3 is a schematic view of the preparation of a wash coat comprising a metal-containing core-shell hybrid Chabazite material according to the teachings of the present disclosure; and

FIG. 4 is a graphical representation of the ammonia desorption profile exhibited by the core shell hybrid Chabazite material formed according to FIG. 1 after being hydrothermally aged (800° C. for 6 hours, 10% H2O).

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally provides a core-shell hybrid Chabazite (CHA) material that exhibits catalytic activity for Selective Catalytic Reduction (SCR) reactions. This zeolite-type material as prepared according to the synthesis conditions described herein exhibits high catalytic activity initially equivalent to Chabazite (CHA) catalysts that have a silicon to aluminum ratio (SAR) on the order of about 25-30 and after hydrothermal aging a level of activity that is equivalent to or higher than existing Chabazite zeolites having an SAR between 12 to 14, as demonstrated by ammonia and N-propylamine temperature desorption studies.

The following specific embodiments are given to illustrate the preparation, identification, and use of the core-shell hybrid Chabazite (CHA) materials prepared according to the teaching of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

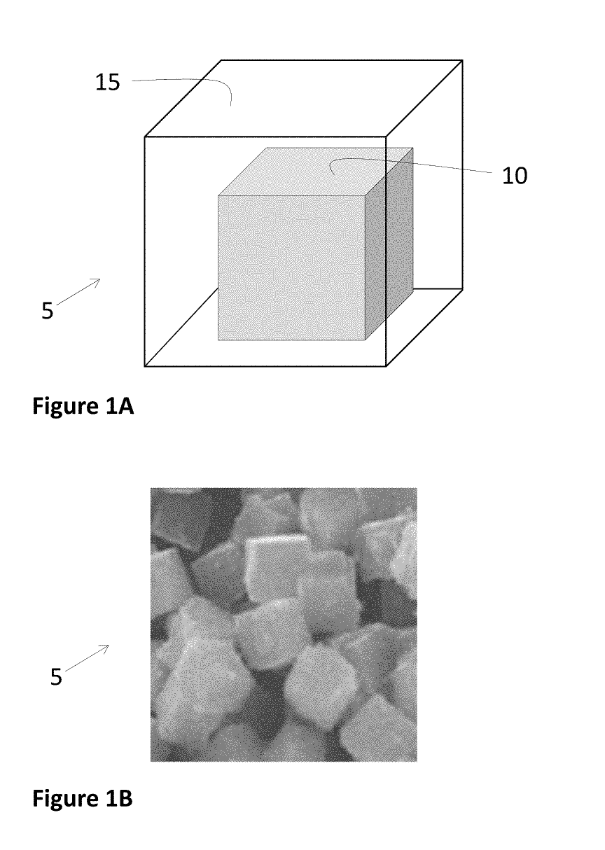

Referring to FIGS. 1A and 1B, the core-shell hybrid Chabazite (CHA) material 5 comprises, consists of, or consists essentially of a core 10 of a Chabazite (CHA) material having silicon to aluminum (SAR) ratio that is less than 25 and a shell 15 of a Chabazite (CHA) material having SAR that is equal to or greater than 25 that at least partially encapsulates the core 10. Alternatively, the core 10 has an SAR that is less than 20; alternatively, less than 15; alternatively between about 8 and about 15; alternatively, between about 12 and about 14. The shell 15 may alternatively have an SAR between about 25 and about 80; alternatively, between about 25 and about 50; alternatively, between about 25 and about 30. When desirable, the core 10 may be similar to SSZ-13 zeolite phase having an SAR of about 13 and the shell 15 may be similar to SSZ-25 zeolite phase having an SAR of about 25.

The shell 15 at least partially encapsulates the core 10 in the core-shell CHA material 5. Alternatively, the core 10 is entirely encapsulated by the shell 15. It is also possible to have a mixture of core-shell particles or crystallites in the core-shell CHA material 5 in which some of the cores 10 are partially encapsulated with the shell 15 and some of the cores 10 are entirely or substantially encapsulated in the shell 15. The core-shell Chabazite (CHA) material crystallizes in a triclinic crystal system which includes rhombohedral shaped particles that are pseudo-cubic in shape as shown in FIGS. 1A and 1B. The particles may be twinned with contact twinning and/or penetration twinning being present. Particle twinning occurs when two separate particles or lattice structures share some of the same lattice sites in a symmetrical manner.

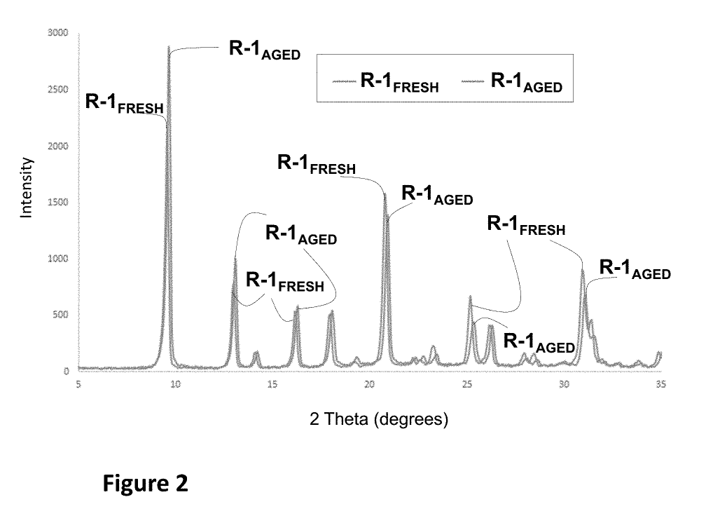

Referring now to FIG. 2, the core-shell material exhibits peaks in an x-ray diffraction pattern with a 2 theta degree at about 9.5, 13.0, 16.5, 18.5, 21.5, 25.4, 26.4, and 31. After being subjected to hydrothermal aging at 800° C. for 6 hours, the material exhibits peaks in an x-ray diffraction patter with a 2 theta degree that are substantially the same as the peaks exhibited by the freshly prepared material. In addition, the core-shell hybrid CHA material exhibits a surface area that is greater than 400 m²/g; a pore volume that is at least 0.15 cm³/g; and a pore size or diameter that is greater than 1.0 nm after hydrothermal aging at 800° C. for 6 hours. Alternatively, the core-shell hybrid CHA material after hydrothermal aging at 800° C. for 6 hours exhibits a surface area that is greater than 500 m²/g; a pore volume that is at least 0.20 cm³/g; and a pore size or diameter that is equal to or greater than 2.0 nm after hydrothermal aging at 800° C. for 6 hours. The average particle size of the core-shell hybrid CHA material is between about 0.25 micrometers (μm) and about 5 μm; alternatively, between about 0.5 μm and about 2 μm.

The core-shell hybrid CHA materials formed according to the teachings of the present disclosure exhibit an ammonia (NH₃) absorption that is greater than 1.25 mmol/g of material when freshly prepared; alternatively, greater than about 1.50 mmol/g of material; alternatively, greater than about that is greater than 1.75 mmol/g of material alternatively, about 1.75 mmolg/g to about 2.25 mmol/g of material; alternatively, about 2 mmol/g of material. Upon hydrothermal aging at 800° C. for 6 hours, the core-shell hybrid CHA materials retain an ammonia (NH₃) absorption value that is greater than 0.3 mmol/g of material; alternatively, greater than about 0.4 mmol/g of material; alternatively, between about 0.4 mmol/g of material to about 0.6 mmol/g of material.

The shell of the core-shell hybrid CHA materials may be characterized as having Broensted acid sites that are present in a greater number than such sites in the core of the core-shell hybrid CHA materials. Although not wanting to be held to theory, the presence of these Broensted acid sites are believed to result in the core-shell hybrid CHA material exhibiting greater than a 50% increase in n-propylamine temperature desorption over an SSZ-13 zeolite after being subjected to hydrothermal aging at 800° C. for 6 hours.

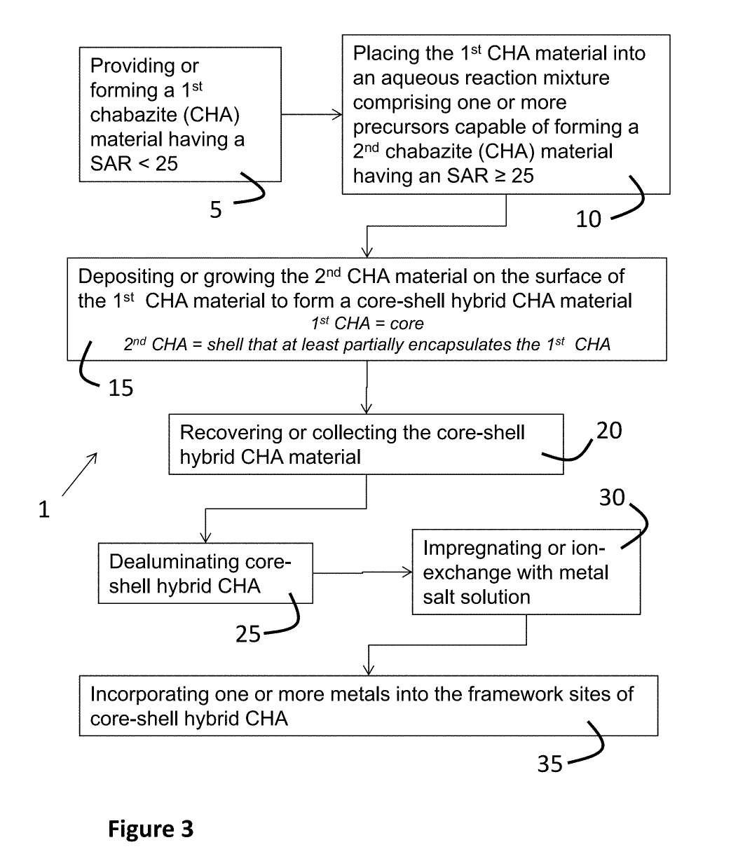

Referring to FIG. 3, a method 1 for preparing core-shell hybrid Chabazite (CHA) materials of the present disclosure and using said hybrid materials to form a wash coat is provided. The method generally comprises, consists of, or consists essentially of providing 5 or forming a first Chabazite (CHA) material having silicon to aluminum ratio (SAR) that is less than 25. The 1^{st} CHA material is placed 10 into an aqueous reaction mixture comprising one or more precursors capable of forming a second Chabazite (CHA) material having SAR that is equal to or greater than 25. The 2^{nd} CHA material is deposited 15 or allowed to grow on the surface of the 1st CHA material to form a core-shell hybrid CHA material. The core-shell hybrid CHA material has a core comprising the 1st CHA material and a shell comprising the 2^{nd} CHA material that at least partially encapsulates the core. Alternatively, the shell substantially encapsulates the core. The core-shell hybrid CHA material is collected 20 or recovered. When desirable, the reaction mixture may include an organic structure directing agent (SDA), such as, without limitation, N,N,N-trimethyl-1-adamantamonium hydroxide.

Still referring to FIG. 3, a wash coat is formed in that incorporates 35 at least one metal into the framework sites of dealuminated core-shell hybrid Chabazite (CHA) material. The core-shell hybrid CHA material is subjected to a process that results in partial dealumination 25 of the material. The dealumination of the material may be accomplished by any known means including but not limited to methods that use diluted acid or ammonium nitrate solutions; alternatively, with nitric acid. The dealuminated material is impregnated 30 with or subjected to ion-exchange with a metal salt solution. One or more metals are incorporated 35 into the framework sites of the core-shell hybrid CHA. The metal cations from the metal salt solution occupy sites in the zeolite framework previously occupied by aluminum (Al) cations. The metal-containing, core-shell hybrid CHA material may function as a catalyst in a selective catalytic reduction (SCR) reaction

The amount of metal present in the metal-containing core-shell hybrid Chabazite (CHA) material ranges from about 0.1 wt. % to about 5 wt. %; alternatively, from about 0.3 wt. % to about 5 wt. %, based on the total weight of the metal-containing core-shell hybrid Chabazite (CHA) material. The lattice structure or framework core-shell hybrid CHA material exhibits a pore size or diameter that is typically less than about 10 nanometers; alternatively, less than about 6 nanometers.

Metals may be introduced into the zeolite by replacing some of the existing cations with metal cations via standard ion exchange techniques, such as those described in U.S. Pat. Nos. 3,140,249, 3,140,251, and 3,140,253, the contents of which are hereby incorporated by reference. Typical cation replacement may include the use of metal cations that are selected from the groups 1 through 12 of the Periodic Table, and mixtures thereof, with a preference toward the elements of the group 1, 2 and 8 of the Periodic Table. Alternatively, the metal is as one from the group of Copper (Cu), iron (Fe), cobalt (Co), zirconium (Zr), titantium (Ti), or a mixture thereof.

Zeolites with transition metals incorporated within the framework exhibit different and very often valuable catalytic properties. For example, cobalt-containing zeolites have been the subject of much interest over the last years, largely because of their catalytic performance in the selective catalytic reduction (SCR) of nitrogen oxides with methane. This reaction is important because methane is expected to replace ammonia as a reductant of NO emitted from stationary sources. U.S. Publication No. 2008/0226545A1 discloses the use of copper exchanged zeolites in the control of NOₓ emissions from gaseous media over a broad temperature range using selective catalytic reduction of nitrogen monoxide by ammonia.

A significant factor that affects the catalytic activity of zeolite catalysts is the preparation route selected for the catalyst. For example, Janas et al. in Applied Catalysis B: Environmental, 91, (2009), p. 217, describes the effect of copper content on the catalytic activity of a Copper beta zeolite (CuSiBEA) in the selective catalytic reduction (SCR) of NOₓ. It is possible to control the incorporation of copper into the framework of the beta zeolite by a two-step post-synthesis method to obtain the CuSIBEA catalyst.

The process of the present disclosure provides a method for preparing a core-shell hybrid Chabazite (CHA) material with different silicon to alumina ratios (SAR) exhibited by the core of hybrid material and the shell of the hybrid material. The method may optionally comprise the step of heating the core-shell hybrid Chabazite (CHA) material after impregnation with the aqueous metal salt solution to a temperature of at least 150° C., alternatively about 160° C. The zeolite framework has a pore size that is typically less than 10 nanometers; alternatively less than 6 nanometers; alternatively, between about 1 nanometer and 4 nanometers.

The metal-containing core-shell hybrid Chabazite (CHA) materials prepared according to the teachings of the present disclosure may be used as catalysts, such as in SCR applications. The metal-containing core-shell hybrid CHA material comprises a sufficient amount of a metal to maintain NOₓ conversion performance in an exhaust gas stream containing nitrogen oxides. The NOₓ conversion performance of a fresh catalyst at about 500° C. is about 70%. The NOₓ conversion performance of the hydrothermally aged catalyst at about 200° C. is about 30%.

The acid strength of the synthesized zeolite materials is monitored by measuring the temperature that molecules with basic character (e.g., ammonia and N-propylammine) are desorbed (temperature programmed desorption measurements). The acidity of the samples are measured by ammonia temperature-programmed desorption, and N-propylamine-TPD techniques. Optionally, the metal-containing core-shell hybrid Chabazite (CHA) materials may be deposited onto a honeycomb structure, including but not limited to a wall flow substrate; a metal substrate, or a formed extrudate.

The replacement of aluminum within the structure of the core-shell hybrid Chabazite (CHA) with Cu, Fe, Co, Zr, Ti, or a mixture thereof increases the SCR activity of the catalyst. The core-shell hybrid Chabazite (CHA) with a metal in the framework lattice is capable of storing less ammonia. This metal substitution process reduces the amount of BrOnsted Acid sites present in the catalyst and replaces such sites with Lewis Acid sites. Overall the metal replacement reduces the NOₓ slip that occurs in ammonia SCR catalysts.

### Example 1—Characterization of Core-Shell Hybrid CHA Materials

A core-shell hybrid Chabazite (CHA) material (R-1) was prepared according to the method defined above and described in FIG. 3. The resulting material was characterized by XRD. The pattern was obtained from 5 to 35° 2θ using a step size of 0.02° 2θ. Scanning electron microscopy (SEM) images and energy-dispersive X-ray spectroscopy (EDAX) chemical analysis were obtained using a Carl-Zeiss microscope. Temperature desorption studies were carried out on a 2920 Micromeritics instrument coupled with a MKS Cirrus Mass Spectrometer. All synthesized materials are white powders.

The X-ray diffraction pattern of the core-shell hybrid CHA material (R-1) is shown in FIG. 2 as R-1_{FRESH}. The core-shell hybrid CHA material (R-1_{FRESH}) was subjected to hydrothermal aging at 800° C. for 6 hours with the X-ray diffraction pattern of the aged material (R-1_{AGED}) being measured to provide substantially the same peak absorptions as found in the R-1 FRESH material. The properties measured for the core-shell hybrid CHA material after hydrothermal aging (R-1_{AGED}) included a surface area of 503.6 m2/g, a pore volume of 0.25 cm3/g, and a pore diameter of 2.0 nm.

Temperature-programmed desorption of basic molecules NH₃ and N-propyalamine are applied to study the overall nature and distribution of the acid sites on the existing SSZ-13, and the PIDC zeolite-type materials prepared herein. TPD spectra are recorded on 2920 Micromeritic instrument connected with a thermal conductivity detector (TCD) in MKS Cirrus Mass Spec equipment.

Typically for NH₃-TPD, 0.1 g catalyst is pretreated at 500° C. for 30 minutes at a rate of 20° C./min in helium flowing at 25 mL min⁻¹ and then cooled to adsorption temperature of 100° C. The catalyst is saturated with diluted ammonia (10% Ammonia/90% Argon) at 100° C. for 30 minutes. After saturation the sample is purged with helium at 25 mL min⁻¹, for 20 minutes to remove the weakly adsorbed ammonia on the surface of the zeolite. The temperature of the sample is then raised at a heating rate of 20° C./min from 100° C. to 650° C., with the flow helium maintained at 25 mL min⁻¹, and then finally held at 650° C. for 40 minutes. A mass spectrometer is used to monitor desorbed NH₃.

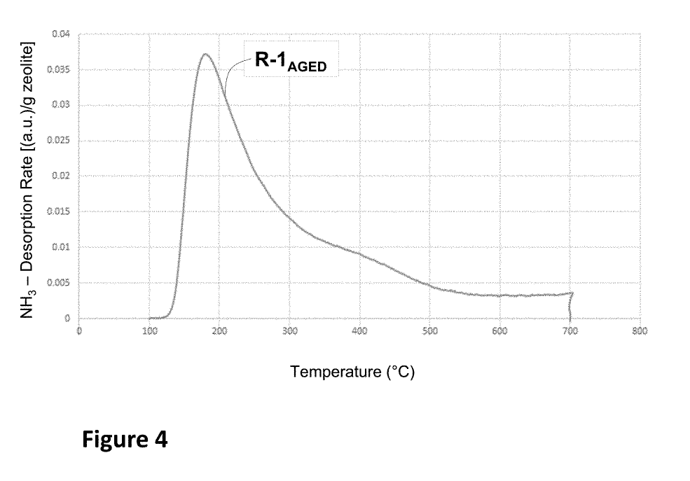

The amounts of ammonia desorbed from the cone-shell hybrid CHA material both after being freshly prepared (R-1 FRESH) and after be hydrothermally aged (R-1 AGED) determined from their measured TPD peak areas. Two NH₃ desorption peaks are observed in the measured ammonia desorption profile as shown in FIG. 4 for the R-1_{AGED} material. The NH₃ desorption peak at ˜160° C. is associated with weak acid sites and the other smaller peak at about 400° C. is associated with strong acid sites. The freshly prepared material (R-1_{FRESH}) and the aged material (R-1_{AGED}) show different acidity. The adsorption performance of the R-1_{FRESH} material is measured to be 1.95 mmol/g, which is slightly lower than commonly obtained for a fresh, pure SSZ-13 material. However, the hydrothermally aged material (R-1_{AGED}) exhibited an absorption performance of about 0.43 mmol/g of material, which is substantially higher than commonly obtained with an aged SSZ-13 material.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A crystalline, core-shell hybrid Chabazite (CHA) material for use as a catalyst, the core-shell hybrid CHA material comprising:
a core having a silicon to aluminum ratio (SAR) that is less than 25; and
a shell that at least partially encapsulates the core, the shell having an SAR of about 25 or greater.

2. The core-shell hybrid CHA material according to claim 1, wherein the SAR of the core is between about 10 to 15 and the SAR of the shell is about 25 to 50.

3. The core-shell hybrid CHA material according to claim 2, wherein the SAR of the core is between 12 to 14 and the SAR of the shell is about 25 to 30.

4. The core-shell hybrid CHA material according to claim 3, wherein the SAR of the core is about 13 and the SAR of the shell is about 25.

5. The core-shell hybrid CHA material according to claim 1, wherein the core is equivalent to an SSZ-13 zeolite phase and the shell is equivalent to an SSZ-25 zeolite phase.

6. The core-shell hybrid CHA material according to claim 1, wherein the material exhibits peaks in an x-ray diffraction pattern with a 2 theta degree at as shown in FIG. 2, when the material is freshly prepared.

7. The core-shell hybrid CHA material according to claim 6, wherein after hydrothermal aging at 800° C. for 6 hours, the material exhibits peaks in an x-ray diffraction patter with a 2 theta degree that are substantially the same as the peaks exhibited by the freshly prepared material.

8. The core-shell hybrid CHA material according to claim 1, wherein after hydrothermal aging at 800° C. for 6 hours the core-shell hybrid CHA material exhibits a surface area greater than 500 m²/g; a pore volume that is at least 0.20 cm³/g and a pore size greater than 1.5 nm.

9. The core-shell hybrid CHA material according to claim 1, wherein the core-shell hybrid CHA materials exhibits an ammonia (NH₃) absorption that is greater than 1.7 mmol/g material when freshly prepared and an ammonia (NH₃) absorption that is greater than 0.3 mmol/g material after being hydrothermally aged at 800° C. for 6 hours.

10. The core-shell hybrid CHA material according to claim 9, wherein the core-shell hybrid CHA materials exhibits an ammonia (NH₃) absorption that is about 1.95 mmol/g material when freshly prepared and an ammonia (NH₃) absorption that is about 0.43 mmol/g material after being hydrothermally aged at 800° C. for 6 hours.

11. The core-shell hybrid CHA material according to claim 1, wherein the shell is characterized by Broensted acid sites that are present in a greater number than such sites in the core;
wherein the Broensted acid sites results in the core-shell hybrid CHA material exhibiting greater than a 50% increase in n-propylamine temperature desorption over an SSZ-13 zeolite after hydrothermal aging at 800° C. for 6 hours.

12. The core-shell hybrid CHA material according to claim 1, wherein the core-shell hybrid CHA material further includes a metal selected as one from the group of copper (Cu), iron (Fe), cobalt (Co), zirconium (Zr), titanium (Ti), and a mixture thereof;
wherein the metal-containing, core-shell hybrid CHA material functions as a catalyst in a selective catalytic reduction (SCR) reaction.

13. The core-shell hybrid CHA material according to claim 12, wherein the metal present in the catalyst ranges from 0.3 to 10.0%, based on the total weight of the core-shell hybrid CHA material.

14. The core-shell hybrid CHA material according to claim 12, wherein the catalyst contains ion-exchanged metal Cu, Fe, Co, Zr, or Ti, sufficient to maintain NOₓ conversion performance in an exhaust gas stream containing nitrogen oxides;
wherein the NOₓ conversion performance of the fresh catalyst at about 500° C. is about 70%.

15. The core-shell hybrid CHA material according to claim 14, wherein the catalyst is hydrothermally aged and the NOₓ conversion performance of the hydrothermally aged catalyst at about 200° C. is about 30%

16. The core-shell hybrid CHA material according to claim 12, wherein the metal-containing, core-shell hybrid CHA material is deposited onto a honeycomb structure, a metal substrate, or a formed extrudate.

17. A method of preparing a meta-containing catalyst, the method comprising the steps of:
dealuminating the core-shell hybrid Chabazite (CHA) material of claim 1;
impregnating or ion-exchanging the dealuminated zeolite with an aqueous metal salt solution; and
incorporating a metal selected as one from the group of Cu, Fe, Co, Zr, Ti, or a mixture thereof into the framework sites of dealuminated core-shell hybrid Chabazite (CHA) material.

18. The method according to claim 17, wherein the catalyst incorporates the metal in the framework in an amount sufficient to maintain NOₓ conversion performance in an exhaust gas stream containing nitrogen oxides.

19. The method according to claim 17, wherein the method further comprises depositing the catalyst onto a honeycomb substrate, a metal substrate or an extruded substrate and optionally, a wall flow substrate.

20. The method according to claim 17, the method further comprising preparing the core-shell hybrid CHA material by:
providing or forming a first chabazite (CHA) material having a silicon to aluminum ratio (SAR) that is less than 25;
placing the first CHA material into an aqueous reaction mixture comprising one or more precursors capable of forming a second chabazite (CHA) material having an SAR that is 25 or greater;
depositing or growing the second CHA material on the surface of the first CHA material, such that a core-shell hybrid CHA material is formed, in which the first CHA material is a core and the second CHA material is a shell that at least partially encapsulates the first CHA material; and
recovering or collecting the core-shell hybrid CHA material.
